(19) United States
(12) Patent Application Publication
(10) Pub. No.: US 2016/0056635 A1
(43) Pub. Date: Feb. 25, 2016

(54) Systems and Methods for Tracking the Status and Usage Information of a Wireless Power Transmission System

(71) Applicant: ENERGOUS CORPORATION, Pleasanton, CA (US)

(72) Inventor: Douglas Bell, Pleasanton, CA (US)

(21) Appl. No.: 14/465,532

(22) Filed: Aug. 21, 2014

(51) Int. Cl. H02J 5/00; H02J 7/02; G06F 1/26

(52) U.S. Cl. CPC H02J 5/005; G06F 1/26; H02J 7/025

(57) ABSTRACT

Disclosed here are methods and systems to generate and distribute information about the status and usage of a wireless power transmission system. Specifically, the present disclosure may describe a process to generate information through various software running in different components of the wireless power transmission system. Additionally, the disclosure may also include a wireless power transmission system architecture which may include components, such as a remote information service, a remote information service manager, a remote information service database, one or more authorized computing devices, and a plurality of system information generators. System information generator may refer to components, such as wireless power transmitters, computing devices/non computing devices (coupled with power receiver devices), a system management service, and distributed system database. The aforementioned components within the wireless power transmission system may be used to automatically and autonomously generate, store, transmit, and distribute system status, usage, and statistics or metrics information in order to be edited or reported by authorized and authenticated users. The information may also be used to increase the accuracy of strategic marketing, sales focus, to alert customer service of system problems and performance issues, and for billing end users.

### CROSS-REFERENCE TO RELATED APPLICATIONS

The present disclosure is related to U.S. non-provisional patent application DWV-3DPF-010 entitled “Methodology for Pocket-forming”; and DWV-3DPF-028 entitled “Methodology for Multiple Pocket-Forming”; DWV-3DPF-015 entitled “Method for 3 Dimensional Pocket-forming”; DWV-3DPF-027 entitled “Receivers for Wireless Power Transmission”; DWV-3DPF-029 entitled “Transmitters for Wireless Power Transmission” invented by Michael Leabman.

### BACKGROUND

1. Field of the Disclosure

The present disclosure relates in general to wireless power transmission systems, and more specifically to systems and methods to automatically and autonomously generate, store, transmit, and distribute the status and usage information from a multiple wireless power transmission system.

2. Background Information

Electronic devices such as laptop computers, smartphones, portable gaming devices, tablets and so forth may require power for performing their intended functions. This may require having to charge electronic equipment at least once a day, or in high-demand electronic devices more than once a day. Such an activity may be tedious and may represent a burden to users. For example, a user may be required to carry chargers in case his electronic equipment is lacking power. In addition, users have to find available power sources to connect to. Lastly, users must plug in to a wall power socket or other power supply to be able to charge his or her electronic device.

An approach to mitigate this issue may include using RF waves through suitable power transmission techniques such as pocket-forming. This approach may provide wireless power transmission while eliminating the use of wires or pads for charging devices. In some cases, even batteries may be eliminated as a device may be fully powered wirelessly. The approach may enable the creation of wireless power transmission systems where one or more wireless power transmitters coordinates to provide wireless power charging to one or more wireless power receivers.

A wireless power transmission system includes a source device and a target device. The source device wirelessly transmits power, and the target device wirelessly receives power. The source device may be referred to as a wireless power transmitter, and the target device may be referred to as a wireless power receiver. During transfer process of wireless power between source and target devices, there is a need by the system owners or operators to know information to determine if the system is operating correctly or has problems. Additionally, there is a need to obtain information regarding how the system is being used and which features and components are used the most, as well as, the status of the system, errors, faults, trouble reports, and logs of operational events, among others.

Therefore, there is a need for providing methods to address these and other concerns.

### SUMMARY

Disclosed here are wireless power transmission systems which may generate information regarding the status and usage of the system. Specifically, the wireless power transmission system may include a monitoring system that may receive a generated status and usage information, and then provides it for distribution to other computer devices in any way, such as through the Internet cloud or other. Said status and usage information may include status, usage, data, errors, faults, values, measurements, records, files of any aspect of the system's software, hardware, communication, performance, among others, including past or present. Said distribution of status and usage information may be provided to third party companies in return for a fee.

The wireless power transmission system may generate information to determine the system′ working status, the system usage, and which features and components are used the most, among others. According to an embodiment, the wireless power transmission system may be able to automatically and autonomously generate, store and transmit information through a remote information service. The wireless power transmission system may include software which may run on any suitable computing device in order to provide statistic and/or metric information. In addition, the components included within a wireless power transmission system architecture may be a remote information service, a remote information service manager, a remote information service database, one or more authorized computing devices, and a plurality of system information generator. In addition, the system information generator may refer to components, such as wireless power transmitters, wireless power receivers, computing devices/non computing devices (coupled with wireless power receiver devices), system management service, back-end servers, and distributed system database.

The remote information service may be a remote cloud-based information service that may collect and store information from the wireless power transmission system for distribution, and then report or edit the information on demand. The information on demand may be used for decision making by authorized users.

The system information generator may be able to provide information regarding the status and usage of the system that includes component usage, status of the system, errors, faults, problems, trouble reports, logs of operational events, each command issued by each user, user configurations, amount of power transmitted per power transmitter and per power receiver, metrics of all software and hardware activity, values measured or read from hardware of the system, metrics and details of every automatic operation performed by the system software, description and details of present and past location of all client devices and power receivers of said system, details of hand-off of control of power receiver from one power transmitter unit to another, all user scheduled configuration, all identifications of all system components, and all software defined version labels for system components, among others.

Additionally, the system information generator may store the information into a distributed system database. Included in the system database distribution is also the database within the remote information service.

The present disclosure may also include a process to generate information regarding the usage and status of the disclosed system and method. The process may start when a customer through the computing device gets access to the wireless power transmission system operability, where the system information generator through a validation process may establish communication with the remote information service; previously to the aforementioned step the system information generator may generate the information on demand; subsequently, the information may be stored in the distributed system database, and then it may be transmitted to the remote information service where a suitable computing device may access through a network connection. Finally, the computing device operated by the authorized user may download, report and/or edit the information coming from the remote information service.

The information about the usage and status of the wireless power transmission system, generated by the wireless power transmission system, may help to provide accurate statistics or metrics describing the system operability in order increase sales focus, increase accuracy of strategic marketing, and to manage the information.

Numerous other aspects, features and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a wireless power transmission example situation using pocket-forming.

FIG. 2 illustrates a component level embodiment for a transmitter, according to an embodiment.

FIG. 3 illustrates a component level embodiment for a receiver, according to an embodiment.

FIG. 4 illustrates an exemplary embodiment of a wireless power network including a transmitter and wireless receivers.

FIG. 5 illustrates a wireless power transmission system architecture, according to an exemplary embodiment.

FIG. 6 is a flowchart of a process to determine the status and usage information from a wireless power transmission system, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“App” may refer to a software application that is run on a mobile, laptop, desktop, or server computer

“Adaptive pocket-forming” may refer to dynamically adjusting pocket-forming to regulate power on one or more targeted receivers.

“BTLE”, or “BLE”, may refer to Bluetooth Low Energy communication hardware and/or software.

“Charge Or Charging” may refer to the conversion of RF energy into electrical energy by a receiver, using an antenna, where the electrical energy may be transmitted through an electrical circuit connection from the receiver to an electrically connected client device, where the transmitted energy may be used by the device to charge its battery, to power its functions, or any suitable combination.

“Null-space” may refer to areas or regions of space where pockets of energy do not form because of destructive interference patterns of RF waves.

“Operator” may refer to a person who installs or operates the wireless power transmission system. Operator may also be a system user.

“Pairing” may refer to the association, within the wireless power transmission system's distributed system database, of a single electronic client device with a single power receiver. In one or more embodiments, this may allow a system to determine from said association which power receiver to transmit power to in order to charge said client device upon receiving a command, from a user or automatic system process, that a client device is to be charged.

“Pocket-forming” may refer to generating two or more RF waves which converge in 3-D space, forming controlled constructive and destructive interference patterns.

“Pocket of Energy” may refer to areas or regions of space where energy or power may accumulate in the form of constructive interference patterns of RF waves.

“Power” may refer to electrical energy, where “wireless power transmission” may be synonymous of “wireless energy transmission”, and “wireless power transmission” may be synonymous of “wireless energy transmission”.

“Receiver” may refer to a device including at least one antenna element, at least one rectifying circuit and at least one power converter, which may utilize pockets of energy for powering, or charging an electronic device.

“System” may refer to a wireless power transmission system that wirelessly transmit power from a transmitter to a receiver.

“System Computer” may refer to one of the computers of a wireless power transmission system; is part of the communication network between all computers of the wireless power transmission system; may communicate through said network to any other system computer; and may be a wireless power transmitter, a wireless power receiver, a client device, a management service server, or any other.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“User” may refer to a person using the system to provide wireless power transmission to a client device. User may be an operator.

“WIFI” may refer to Wireless network.

### DESCRIPTION OF THE DRAWINGS

The present disclosure describes a multiple wireless power transmission system used to generate information to determine the system working status, the system usage, and which features and components are used the most, among others. Additionally, the wireless power transmission system may include a monitoring system that may receive a generated status and usage information, and then provides it for distribution to other computer devices in any way, such as through the Internet cloud or other. The wireless power transmission system may be able to automatically and autonomously generate, store and transmit information through a remote information service.

Wireless Power Transmission System Including Disclosed Concepts:

Methods disclosed here may be part of a wireless power transmission system including two or more wireless power transmitters, one or more wireless power receivers, one or more optional system management servers; and one or more optional mobile or hand-held computers, smart phones, or the like, that run the system management GUI app. This app may be made available at, downloaded, and installed from a public software app store or digital application distribution platform, such as Apple's iTunes, Google's Play Store, Amazon's Appstore, and the like.

The power transmitters and management servers may all communicate with each other through a distributed system database, and may also communicate present status and any status change to a remote information service that may be located within the Internet cloud.

One or more wireless power transmitters may automatically transmit power to any single wireless power receiver that is close enough for it to establish a communication connection with, using a suitable communication technology, including Bluetooth Low Energy or the like. The receiver may then power or charge an electrically connected client computing device, such as mobile device, toy, remote control, lighting device, and the like. A single wireless power transmitter may also power multiple wireless power receivers simultaneously.

Alternately, the system can be configured by the system management GUI to automatically only transmit power to specific wireless power receivers depending on specific system criteria or conditions, such as the time or hour of the day for automatic time-based scheduled power transmission, power receiver physical location, owner of client device, or other any other suitable conditions and/or criteria.

The wireless power receiver may be connected electrically coupled to a client device, such a mobile phone, portable light, TV remote control, or any device that would otherwise require a battery or connection to wall power. In one or more embodiments, devices requiring batteries can have traditional batteries replaced by wireless power receiver batteries. The wireless power receiver then receives energy transmitted from the power transmitter, into receiver's antenna, rectifies, conditions, and sends the resulting electrical energy, through an electrical relay switch, to the electrically connected client device to power it or charge it.

A wireless power transmitter can transmit power to a wireless power receiver, which, in response, can power or charge its associated client device while device is in use or in motion anywhere within the power transmission range of the wireless power transmitter. The wireless power transmitter can power multiple devices at the same time.

The wireless power transmitter establishes a real-time communication connection with each receiver for the purpose of receiving feedback in real-time (such as 100 samples per second). This feedback from each receiver may include the measurement of energy presently being received, which is used by the transmitter to control the direction of the transmitter's antenna array so that it stays aimed at the receiver, even if the receiver moves to a different physical 3-D location or is in 3-D motion that changes its physical 3-D location.

Multiple wireless power transmitters can power a given, single receiver, in order to substantially increase power to it.

When a transmitter is done transmitting power to a receiver, it may communicate to the receiver that power transmission has ended, and disconnect communication. The wireless power transmitter may then examine its copy of the distributed system database to determine which, if any, receivers in power range it should next transmit power to.

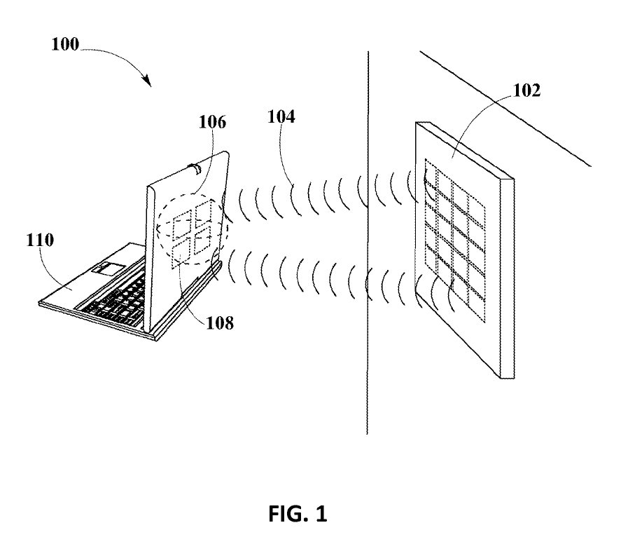

FIG. 1 illustrates wireless power transmission 100 using pocket-forming. A wireless power transmitter 102 may transmit controlled Radio Frequency RF waves 104 which may converge in 3-D space. RF waves 104 may be controlled through phase and/or relative amplitude adjustments to form constructive and destructive interference patterns (pocket-forming). Pockets of Energy 106 may form at constructive interference patterns and may be 3-Dimensional in shape, whereas null-spaces may be generated at destructive interference patterns. A Wireless power receiver 108 may then utilize Pockets of Energy 106 produced by pocket-forming for charging or powering an electronic device, for example a laptop computer 110, and thus providing wireless power transmission 100. In embodiments disclosed here, there may be two or more wireless power transmitters 102 and one or more wireless power receivers 108 for powering various electronic devices. Examples of suitable electronic devices may include smartphones, tablets, music players, and toys, amongst others. In other embodiments, adaptive pocket-forming may be used to regulate power on suitable electronic devices.

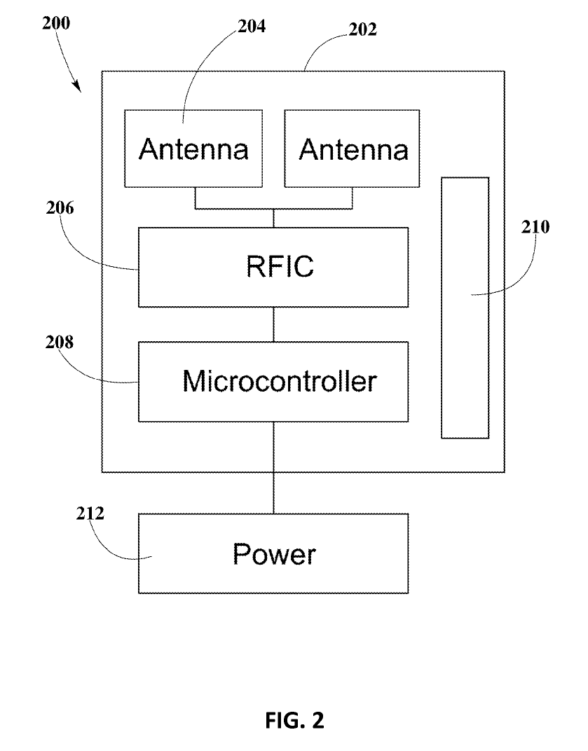

FIG. 2 illustrates a component level embodiment for a wireless power transmitter 200 which may be utilized to provide wireless power transmission 100 as described in FIG. 1. Wireless power transmitter 200 may include a housing 202 where at least two or more antenna elements 204, at least one RF integrated circuit (RFIC 206), at least one digital signal processor (DSP) or micro-controller 208, and one optional communication component 210 may be included. Housing 202 can be made of any suitable material which may allow for signal or wave transmission and/or reception, for example plastic or hard rubber. Antenna elements 204 may include suitable antenna types for operating in suitable frequency bands, such as 900 MHz, 2.5 GHz, or 5.8 GHz, and any other frequency bands that may conform to Federal Communications Commission (FCC) regulations part 18 (Industrial, Scientific and Medical equipment) or any other suitable regulations. Antenna elements 204 may include vertical or horizontal polarization, right hand or left hand polarization, elliptical polarization, or other suitable polarizations as well as suitable polarization combinations. Suitable antenna types may include, for example, patch antennas with heights from about ⅛ inches to about 6 inch and widths from about ⅛ inches to about 6 inch. Other antenna elements 204 types may be used, including meta-materials, dipole antennas, and others. RFIC 206 may include a chip for adjusting phases and/or relative magnitudes of RF signals, which may serve as inputs for antenna elements 204 for controlling pocket-forming. These RF signals may be produced using an external power supply 212 and a local oscillator chip (not shown in FIG. 2) using a suitable piezoelectric materials. Micro-controller 208 may then process information sent by a receiver through its own antenna elements 204 for determining optimum times and locations for pocket-forming. In some embodiments, the foregoing may be achieved through communication component 210. Communication component 210 may be based on standard wireless communication protocols which may include Bluetooth, Bluetooth Low Energy, Wi-Fi, and/or ZigBee, amongst others. In addition, communication component 210 may be used to transfer other information, including identifiers for the device or user, battery level, location or other such information. The micro-controller 208 may determine the position of a device using any suitable technology capable of triangulation in communication component 210, including radar, infrared cameras, and sound devices, amongst others.

Multiple wireless power transmitter 200 units may be placed together in the same area to deliver more power to individual power receivers or to power more receivers at the same time, said power receivers being within power reception range of two or more of multiple wireless power transmitters 200.

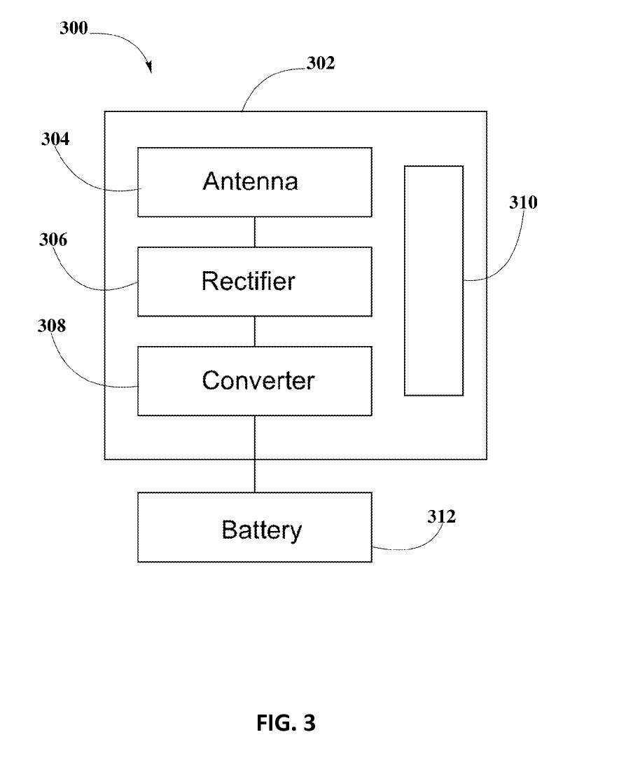

FIG. 3 illustrates a component level embodiment for a wireless power receiver 300 which may be used for powering or charging an electronic device as exemplified in wireless power transmission 100. Wireless power receiver 300 may include a housing 302 where at least one antenna element 304, one rectifier 306, one power converter 308 and an optional communications component 310 may be included. Housing 302 can be made of any suitable material which may allow for signal or wave transmission and/or reception, for example plastic or hard rubber. Housing 302 may be an external hardware that may be added to different electronic equipment, for example in the form of cases, or may be embedded within electronic equipment as well. Antenna element 304 may include suitable antenna types for operating in frequency bands similar to the bands described for wireless power transmitter 200 from FIG. 2. Antenna element 304 may include vertical or horizontal polarization, right hand or left hand polarization, elliptical polarization, or other suitable polarizations as well as suitable polarization combinations. Using multiple polarizations can be beneficial in devices where there may not be a preferred orientation during usage or whose orientation may vary continuously through time, for example a smartphone or portable gaming system. On the contrary, for devices with well-defined orientations, for example a two-handed video game controller, there might be a preferred polarization for antennas which may dictate a ratio for the number of antennas of a given polarization. Suitable antenna types may include patch antennas with heights from about ⅛ inches to about 6 inch and widths from about ⅛ inches to about 6 inch. Patch antennas may have the advantage that polarization may depend on connectivity, i.e. depending on which side the patch is fed, the polarization may change. This may further prove advantageous as a receiver, such as wireless power receiver 300, may dynamically modify its antenna polarization to optimize wireless power transmission. Rectifier 306 may include diodes or resistors, inductors or capacitors to rectify the alternating current (AC) voltage generated by antenna element 304 to direct current (DC) voltage. Rectifier 306 may be placed as close as is technically possible to antenna element 304 to minimize losses. After rectifying AC voltage, DC voltage may be regulated using power converter 308. Power converter 308 can be a DC-DC converter which may help provide a constant voltage output, regardless of input, to an electronic device, or as in this embodiment to a battery 312. Typical voltage outputs can be from about 5 volts to about 10 volts. Lastly, communications component 310, similar to that of wireless power transmitter 200 from FIG. 2, may be included in wireless power receiver 300 to communicate with a wireless power transmitter 200 or to other electronic equipment.

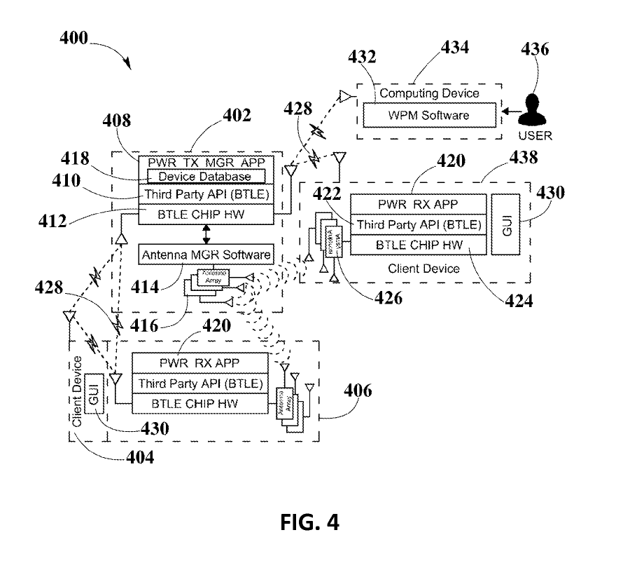

FIG. 4 shows an exemplary embodiment of a wireless power transmission system 400 in which one or more embodiments of the present disclosure may operate. Wireless power transmission system 400 may include communication between one or more wireless power transmitters 402 and one or more powered wireless power receivers 406 and within client device 438. Client device 404 may be paired with an adaptable paired wireless power receiver 406 that may enable wireless power transmission to client device 404. In another embodiment, a client device 438 may include a wireless power receiver 406 built in as part of the hardware of the device. Client device 404 or 438 may be any device which uses an energy power source, such as, laptop computers, stationary computers, mobile phones, tablets, mobile gaming devices, televisions, radios and/or any set of appliances that may require or benefit from an electrical power source.

In one embodiment, one or more wireless power transmitters 402 may include a microprocessor that integrates a power transmitter manager app 408 (PWR TX MGR APP) as embedded software, and a third party application programming interface 410 (Third Party API) for a Bluetooth Low Energy chip 412 (BTLE CHIP HW). Bluetooth Low Energy chip 412 may enable communication between wireless power transmitter 402 and other devices, including wireless power receiver 406, client device 404, and others. Wireless power transmitter 402 may also include an antenna manager software 414 (Antenna MGR Software) to control an RF antenna array 416 that may be used to form controlled RF waves which may converge in 3-D space and create pockets of energy on wireless power receivers 406. In some embodiments, one or more Bluetooth Low Energy chips 412 may utilize other wireless communication protocols, including WiFi, Bluetooth, LTE direct, or the like.

Power transmitter manager app 408 may call third party application programming interface 410 for running a plurality of functions, including the establishing of a connection, ending a connection, and sending data, among others. Third party application programming interface 410 may issue commands to Bluetooth Low Energy chip 412 according to the functions called by power transmitter manager app 408.

Power transmitter manager app 408 may also include a distributed system database 418, which may store relevant information associated with client device 404 or 438, such as their identifiers for a client device 404 or 438, voltage ranges for wireless power receiver 406, location of a client device 404 or 438, signal strength and/or any other relevant information associated with a client device 404 or 438. Database 418 may also store information relevant to the wireless power transmission system 400, including receiver ID's, transmitter ID's, end-user handheld devices, system management servers, charging schedules, charging priorities and/or any other data relevant to a wireless power network.

Third party application programming interface 410 at the same time may call power transmitter manager app 408 through a callback function which may be registered in the power transmitter manager app 408 at boot time. Third party application programming interface 410 may have a timer callback that may go for ten times a second, and may send callbacks every time a connection begins, a connection ends, a connection is attempted, or a message is received.

Client device 438 may include a power receiver app 420 (PWR RX APP), a third party application programming interface 422 (Third party API) for a Bluetooth Low Energy chip 424 (BTLE CHIP HW), and an RF antenna array 426 which may be used to receive and utilize the pockets of energy sent from wireless power transmitter 402.

Power receiver app 420 may call third party application programming interface 422 for running a plurality of functions, including establishing a connection, ending a connection, and sending data, among others. Third party application programming interface 422 may have a timer callback that may go for ten times a second, and may send callbacks every time a connection begins, a connection ends, a connection is attempted, or message is received.

Client device 404 may be paired to an adaptable wireless power receiver 406 via a BTLE connection 428. A graphical user interface (GUI 430) may be used to manage wireless power transmission system 400 from client device 404. GUI 430 may be a software module that may be downloaded from any suitable application store and may run on any suitable operating system, including iOS and Android, amongst others. Client device 404 may also communicate with wireless power transmitter 402 via a BTLE connection 428 to send important data, such as an identifier for the device, battery level information, geographic location data, or any other information that may be of use for wireless power transmitter 402.

A wireless power manager 432 software may be used in order to manage wireless power transmission system 400. Wireless power manager 432 may be a software module hosted in memory and executed by a processor inside a computing device 434. The wireless power manager 432 may include a local application GUI, or host a web page GUI, from where a user 436 may see options and statuses, as well as execute commands to manage the wireless power transmission system 400. The computing device 434 may be connected to the wireless power transmitter 402 through standard communication protocols, including Bluetooth, Bluetooth Low Energy, Wi-Fi, or ZigBee, amongst others. Power transmitter manager app 408 may exchange information with wireless power manager 432 in order to control access and power transmission from client devices 404. Functions controlled by wireless power manager 432 may include scheduling power transmission for individual devices, prioritizing between different client devices 404, accessing credentials for each client, tracking physical locations of power receivers relative to power transmitter areas, broadcasting messages, and/or any functions required to manage the wireless power transmission system 400.

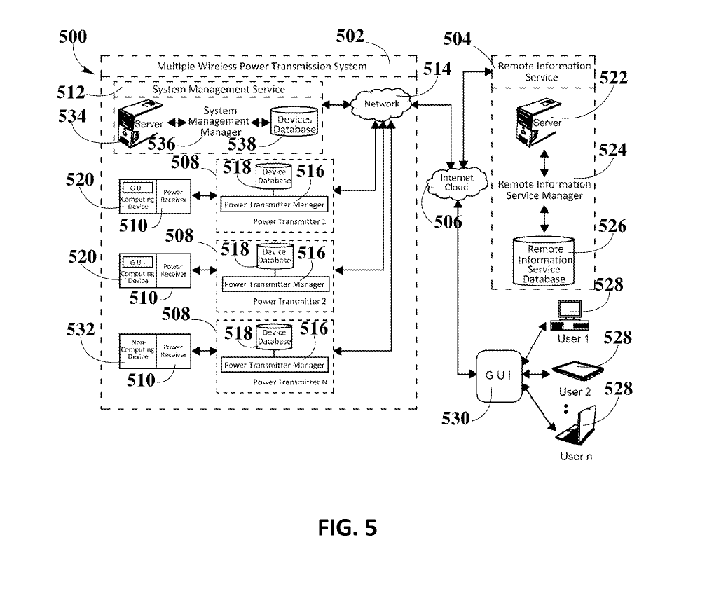

FIG. 5 illustrates a wireless power transmission system architecture 500, according to an exemplary embodiment.

According to some embodiments, wireless power transmission system architecture 500 may include a multiple wireless power transmission systems 502 which may be able to transmit information to a remote information service 504 through an internet cloud 506. In some embodiments, a multiple wireless power transmission system 502 may include one or more wireless power transmitters 508, zero or more computing device 520 coupled with wireless power receivers 510, zero or more non-computing devices 532 coupled with wireless power receivers 510, a system management service 512, and a local network 514. Network 514 connections may refer to any suitable connection between computers such as intranets, local area networks (LAN), virtual private networks (VPN), wireless area networks (WAN), and the internet, among others.

According to some embodiments, each wireless power transmitter 508 may include a wireless power transmitter manager 516 and a distributed system database 518. Each wireless power transmitter 508 may be able to manage and transmit power to one or more wireless power receivers 510, and each wireless power receiver 510 may be able to charge and provide power to computing devices 520 and/or non-computing devices 532. Examples of suitable computing devices 520 may include smartphones, tablets, notebooks, and laptops, amongst others. Examples of suitable non-computing devices 532 may include toys, toothbrushes, LED lights, game remote controls, and music players, amongst others.

Wireless power transmitter manager 516 may be able to control the behavior of wireless power transmitters 508, monitoring different aspects, such as the started time of power transmission, the unique system identification of both wireless power transmitter 508 and wireless power receiver 510, the amount of devices connected, the direction angle of the antennas used, as well as, the voltage at wireless power receiver 510's antenna may be reported; and the real-time communication connection between wireless power transmitter 508 and wireless power receiver 510, which may be used for tracking information from wireless power receiver 510 no matter where it is located or moved; among others.

According to some embodiments, distributed system database 518 may record relevant information from wireless power receivers 510 within computing devices 520/non-computing devices 532, wireless power transmitter 508, and system management service 512. Information may include but is not limited to identifiers for computing devices 520/non-computing devices 532, voltage ranges for computing devices 520/non-computing devices 532, location, signal strength, wireless power receiver 510 ID's, wireless power transmitter 508 ID's, end-user handheld device names ID's, system management server ID's, charging schedules, charging priorities, and/or any data relevant to multiple wireless power transmission system 502. Additionally, wireless power transmitters 508, wireless power receiver 510 within computing devices 520/non-computing devices 532 and system management service 512 may operate as system information generator.

System management service 512 may automatically monitor the database integrity of each computing devices 520, and may automatically communicate with a computing devices 520 to correct a detected error in its database. System management service 512 may include components, such as a system management server 534, a system management manager 536, and a system management database 538.

Distributed system database 518 may be implemented through known in the art database management systems (DBMS) such as, for example, MySQL, PostgreSQL, SQLite, Microsoft SQL Server, Microsoft Access, Oracle, SAP, dBASE, FoxPro, IBM DB2, LibreOffice Base, FileMaker Pro and/or any other type of database that may organize collections of data.

In some embodiments, wireless power transmitters 508 may use network 514 to send and receive information. Network 514 may be a local area network, or any suitable communication system between the components of the multiple wireless power transmission system 502. Network 514 may enable communication between two or more wireless power transmitters 508, the communication of wireless power transmitters 508 with system management service 512, and may facilitate the communication between multiple wireless power transmission system 502 and remote information service 504 through internet cloud 506, amongst others.

Remote information service 504 may be operated by the owner of the system, the manufacturer or supplier of the system, or a service provider. Remote information service 504 may include different components, such as a back-end server 522, a remote information service manager 524, and a general remote information service database 526. Back-end server 522 and remote information service manager 524 may be included into a single physical or virtual server. Remote information service database 526 may include information data in a format or form discernible by remote information service 504, possibly in encrypted form. Additionally, wireless power transmitter 508, computing device 520 and system management service 512, may generate usage and status information in a format or form discernible by remote information service 504, possibly in encrypted form. Remote information service database 526 may be implemented through known in the art database management systems (DBMS) such as, for example, MySQL, PostgreSQL, SQLite, Microsoft SQL Server, Microsoft Access, Oracle, SAP, dBASE, FoxPro, IBM DB2, LibreOffice Base, FileMaker Pro and/or any other type of database that may organize collections of data.

Wireless power transmission system architecture 500 may also include different authorized computing devices 528, which may access remote information service 504 through internet cloud 506 in order to collect and store information about the status and usage of multiple wireless power transmission system 502. Said computing devices 528 may be owned by system owner, manufacturer of system, or client for fee based distribution of status and usage information. The authorized computing devices 528 may be operated by suitable users (e.g. clients, manufacturers or suppliers of the system) in order to determine if the multiple wireless power transmission system 502 is operating correctly (or as expected) or has problems, as well as, to observe how the system is being used by users for marketing or customer service purposes. The collected information may be reported or edited by the authorized computing devices 528 through a user interface 530, which may display different functions, and which may be a web site or other. Said collected information may be provided in return for a fee.

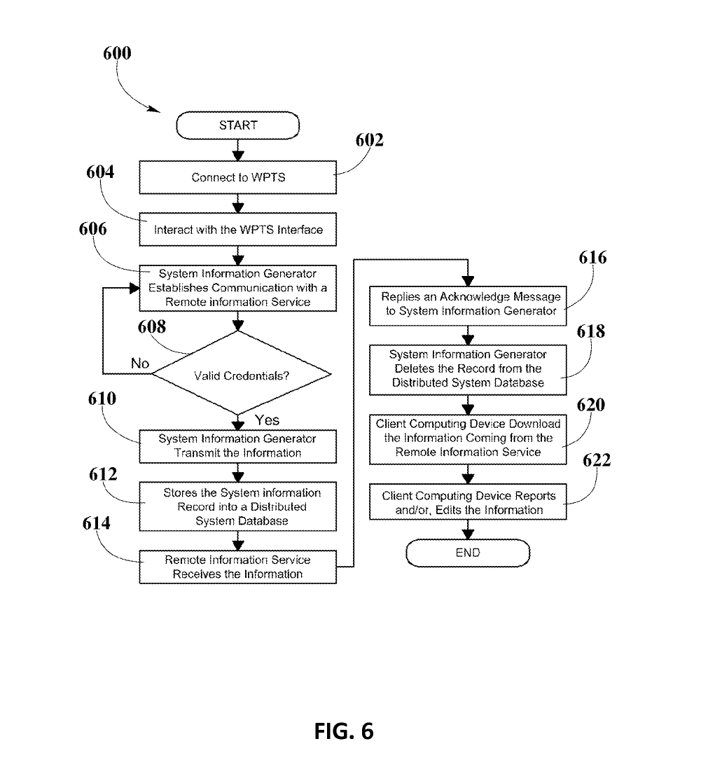

FIG. 6 is a flowchart of a process 600 to determine the status and usage information from a multiple wireless power transmission system. Specifically, the components included within the multiple wireless power transmission system may be a remote information service (cloud-based), a remote information service manager, a distributed system database, and client computing devices, among others. Additionally, each components in the multiple wireless power transmission system, such as wireless power transmitters, computing devices/non computing devices (coupled with wireless power receiver devices), and the system management service, may be considered as a system information generator.

The computing devices and the software modules within the multiple wireless power transmission system, may interact with each other through a suitable network connection. Network connections may refer to any suitable connection between computers such as intranets, local area networks (LAN), virtual private networks (VPN), wireless area networks (WAN), and the internet, among others.

According to one or more embodiments, process 600 may start whenever a client computing device operated by a user, is connected to the multiple wireless power transmission system software (e.g. application software), at step 602. Specifically, the client computing device may initially download and install the multiple wireless power transmission system software from a public or private application store, where the application software may run on any computing device with operating system, such as iOS, Android, and Microsoft Windows, among others. Examples of computing devices may include smartphones, tablets, laptops, music players, and any other computing device.

Once the client computing device is connected to the multiple wireless power transmission system, users may interact with the multiple wireless power transmission system through a user interface displayed on the suitable client computing devices, at step 604. Users interface may allow users to interact with the multiple wireless power transmission system through different options, such as the selection of a computing device to be charged, monitor the status of charge of one or more wireless power receiver, and create a schedule charge for one or more wireless power receiver, report the time when transmission ended, and the total energy or power that was transmitted and received, among others.

The process may continue with step 606, where the system information generator may establish communication with the remote information server. Specifically, the remote information server may be located within the internet cloud or at a physical premises, and may be one or more discreet or virtual computer systems. Additionally, the system information generator may generate and store the information regarding the status and usage of the multiple wireless power transmission system within the distributed system database. Information may include but is not limited to, how all components of the system are used; the present status of the system; other categories of information including but is not limited to, errors, faults, problems, trouble reports, logs of operational events, each command issued by each user, user configurations, amount of power transmitted per power transmitter and per power receiver, metrics of all software and hardware activity, values measured or read from hardware of the system, metrics and details of every automatic operation performed by the system software, description and details of present and past location of all client computing devices and power receivers of the system, details of hand-off of control of power receiver from one power transmitter unit to another, all user scheduled configuration, all identifications of all system components, all software defined version labels for system components; and the present and past information for all of the above, times of occurrence, and identification of each associated system component for each of the above, among others.

The distributed system database may be implemented through known in the art database management systems (DBMS) such as, for example, MySQL, PostgreSQL, SQLite, Microsoft SQL Server, Microsoft Access, Oracle, SAP, dBASE, FoxPro, IBM DB2, LibreOffice Base, FileMaker Pro and/or any other type of database that may organize collections of data.

The software within the system information generator component that manages the distributed system database may automatically establish a secured or encrypted communication connection to verify the credentials of the remote information service, at step 608 via ID code. If the remote information service′ credentials are verified, the system information generator may transmit the information data to the remote information service, at step 610. However, if connection cannot be established with the remote information service, the disclosed system information generator may try again at a later time until said information data has been successfully sent to the remote information service.

Whenever the system information generator generates any information data to be stored in the distributed system database, the system information generator may create a system information record, at step 612, which may include information data in a format or discernible form by the remote information service, possibly in encrypted form. Subsequently, when the information on demand is stored in the distributed system database, the remote information service may receive the information that may come from the system information generator, at step 614. Once the information on demand has been successfully received, remote information service replies with an acknowledgment message to system information generator, at step 616. The information may be stored within a remote information service database. Additionally, the remote information manager within the remote information service may be responsible to execute some actions, such as update information, receive information, store information, and send information to computing devices.

The process may continue at step 618, where once the information on demand has been successfully transmitted, the system information generator may delete the old disposable record of what it just sent to the remote information service from its local copy of the distributed system database in order to not overrun beyond its data storage capacity.

Finally, the authorized client computing device with the validated credentials may download the information from the remote information service, at step 620, and then the authorized client computing device may report and/or edit the information on demand, at step 622 from the multiple wireless power transmission system.

The information may be used for different purposes such as for the observation or verification of past or present expected system status or operation, and system configuration; for the purpose of rapidly detecting and responding to problems, trouble, issues, errors, or faults within said system; for information including but not limited to statistics or metrics describing how the system features are in use for the purpose of increased accuracy of strategic marketing and sales focus; and for information required for billing end users, of the multiple wireless power transmission system, for power received.

### EXAMPLES

Example #1 is an embodiment of a wireless power transmission system where a wireless power transmitter transmits power to a wireless power receiver to charge a client device attached to the receiver. After the transmission of power, said transmitter, also being a system information generator, establishes a communication connection with a remote information service, which may be Internet cloud based. Said transmitter then communicates the detailed usage of the system in transmission of power from said transmitter through said receiver to said client device. Said information service communicates an acknowledgement back to transmitter, and transmitter then deletes the usage information that was sent, to prevent transmitter's memory or database from overflowing. Said information service may then distribute or provide for a fee said information to a user or computing device of another party.

The disclosed information may include, but is not limited to, the time when power transmission started, the unique system identification of both power transmitter and power receiver, the amount and direction angle of antennas used; as well as, the voltage at the power receiver's antenna reported by the power receiver to the power transmitter through the real-time communication connection between the transmitter and the receiver that is used for tracking the receiver no matter the receiver's location or movement.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A processor-based system for managing a power system comprising at least one power transmitter, configured to generate pocket-forming energy in three dimensional space to at least one receiver for charging, the processor-based system comprising:
a processor;
a database operatively coupled to the processor; and
communications, operatively coupled to the processor, wherein the communications is operable to communicate with a network,
wherein the processor is configured to receive system operation data from the at least one power transmitter via the network, wherein the system operation data comprises at least one of power transmitter status and power transmitter usage.

2. The processor-based system of claim 1, wherein the system operation data comprises at least one of errors, faults, trouble reports, logs of operational events, a command issued by the at least one receiver, receiver and transmitter hardware configurations, amount of power transmitted per power transmitter and per power receiver, metrics of software and hardware activity, metrics of automatic operation performed by system software, location of the at least one receiver, power transmitter hand-off of control, and receiver charge scheduling configuration.

3. The processor-based system of claim 1, wherein the network comprises one of a local area network (LAN), virtual private network (VPN) and a wireless area network (WAN).

4. The processor-based system of claim 1, wherein the system operation data is received from a wireless transmitter manager configured within the at least one wireless power transmitter.

5. The processor-based system of claim 1, wherein the processor is configured to authorize system operation data.

6. The processor-based system of claim 1, wherein the processor is configured to transmit, via the communications, system operations data to another processor-based system for managing a power system.

7. The processor-based system of claim 1, wherein the processor is configured to generate a record of the received system operation data.

8. A processor-based method for managing a power system comprising at least one power transmitter, configured to generate pocket-forming energy in three dimensional space to at least one receiver for charging, the method comprising:
configuring communications, operatively coupled to a processor and database, to communicate with a network; and
receiving system operation data from the at least one power transmitter via the communications, wherein the system operation data comprises at least one of power transmitter status and power transmitter usage.

9. The processor-based method of claim 1, wherein the system operation data comprises at least one of errors, faults, trouble reports, logs of operational events, a command issued by the at least one receiver, receiver and transmitter hardware configurations, amount of power transmitted per power transmitter and per power receiver, metrics of software and hardware activity, metrics of automatic operation performed by system software, location of the at least one receiver, power transmitter hand-off of control, and receiver charge scheduling configuration.

10. The processor-based method of claim 1, wherein the network comprises one of a local area network (LAN), virtual private network (VPN) and a wireless area network (WAN).

11. The processor-based method of claim 1, wherein the system operation data is received from a wireless transmitter manager configured within the at least one wireless power transmitter.

12. The processor-based method of claim 1, further comprising the step of authorizing the system operation data.

13. The processor-based method of claim 1, further comprising the step of transmitting, via the communications, system operations data to another processor-based system for managing a power system.

14. The processor-based method of claim 1, further comprising the step of generating, via the processor, a record of the received system operation data.

15. A processor-based system for managing a power system comprising at least one power transmitter, configured to generate pocket-forming energy in three dimensional space to at least one receiver for charging, the processor-based system comprising:
a processor;
a database operatively coupled to the processor; and
communications, operatively coupled to the processor, wherein the communications is operable to communicate with a network, that is further communicatively coupled to the at least one power transmitter configured with a wireless power transmitter manager,
wherein the processor is configured to receive system operation data from the at least one power transmitter via the network, wherein the system operation data comprises at least one of power transmitter status and power transmitter usage.

16. The processor-based system of claim 15, wherein the system operation data comprises at least one of errors, faults, trouble reports, logs of operational events, a command issued by the at least one receiver, receiver and transmitter hardware configurations, amount of power transmitted per power transmitter and per power receiver, metrics of software and hardware activity, metrics of automatic operation performed by system software, location of the at least one receiver, power transmitter hand-off of control, and receiver charge scheduling configuration.

17. The processor-based system of claim 15, wherein the system operation data is received from a wireless transmitter manager configured within the at least one wireless power transmitter.

18. The processor-based system of claim 15, wherein the processor is configured to authorize system operation data.

19. The processor-based system of claim 15, wherein the processor is configured to transmit, via the communications, system operations data to another processor-based system for managing a power system.

20. The processor-based system of claim 15, wherein the processor is configured to generate a record of the received system operation data.
